(19) United States
(12) Patent Application Publication
(10) Pub. No.: US 2002/0082938 A1
(43) Pub. Date: Jun. 27, 2002

(54) Systems, methods and computer program products that facilitate and account for call-through advertising between advertisers and users of web-enabled telephone devices

(76) Inventors: Dana Borger, Cary, NC (US); Steve Cox, Durham, NC (US); Tom Gordon, New York, NY (US); David Spitz, Raleigh, NC (US); Matthew Squire, Raleigh, NC (US); Jay Thrash, Raleigh, NC (US)

Correspondence Address: MYERS BIGEL SIBLEY & SAJOVEC, PO BOX 37428, RALEIGH, NC, 27627, US

(21) Appl. No.: 09/905,799

(22) Filed: Jul. 13, 2001

Related U.S. Application Data
(60) Provisional application No. 60/219,275, filed on Jul. 19, 2000.

(51) Int. Cl. G06F 17/60

(52) U.S. Cl. 705/26

(57) ABSTRACT

Systems, methods, and computer program products that facilitate and account for call-through advertising between third party advertisers and users of Web-enabled telephone devices, are provided. An advertisement server serves an advertisement associated with a third party to a Web-enabled telephone device for insertion within a Web page displayed within the device. The advertisement contains an embedded hyperlink associated with the advertisement server. In response to user activation of the advertisement, the advertisement server serves telephone connection information of the third party to the Web-enabled telephone device. The telephone connection information is in a format that can be utilized by the Web-enabled telephone device to establish telephone communications with the third party. Information associated with serving the telephone connection information to the Web-enabled telephone device is stored. Information associated with a user establishing telephone communications with the third party via the Web-enabled telephone device may also be stored.

### RELATED APPLICATIONS

This application claims the benefit of U.S. Provisional Application No. 60/219,275, filed Jul. 19, 2000, the disclosure of which is incorporated herein by reference in its entirety as if set forth fully herein.

### FIELD OF THE INVENTION

The present invention relates generally to communications networks and, more particularly, to advertising via communications networks.

### BACKGROUND OF THE INVENTION

The Internet has gained broad recognition and acceptance as a viable medium for communicating and for conducting business. The World-Wide Web (Web) is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols and Web content formats.

With the increasing mobility of today's society, the demand for mobile computing capabilities has also increased. Many workers and professionals are downsizing their laptop computers to smaller palm-top or hand-held devices, such as personal digital assistants (PDAs). In addition, many people now utilize wireless devices, such as cellular telephones, to access the Internet and to perform various other computing functions. Wireless devices may include, but are not limited to, PDAs, cellular telephones, pagers, and communicators. Many wireless devices also utilize the Microsoft® Windows® CE and 3Com Palm® Computing platforms. With the advent and development of wireless telecommunications systems and technologies, wireless Internet access is increasing worldwide.

As the Web has evolved into a viable commercial medium, advertising has become an important source of revenue for many business entities. Web pages served from Web sites may utilize advertising to promote various goods and services. For many conventional wireless devices, Web content is displayed as a sequence of displays (cards). To subsidize costs, wireless content publishers may use advertisements mixed with content, often as interstitial displays within a sequence of content displays.

Conventionally, advertisements are served from an advertisement server, as illustrated in FIG. 1. A browser executing within a client device 10 requests an advertisement from an advertisement server 20, represented by 1. The advertisement server 20 returns the advertisement to the client device for insertion within a displayed Web page, represented by 2. When a user clicks on the displayed advertisement, a request is sent to the advertisement server 20, represented by 3. In response, the advertisement server 20 returns a redirection directive associated with a third party advertiser to the browser, represented by 4. The browser follows the redirection to a Web site of the advertiser 25, represented by 5, wherein additional details and/or information can be obtained, represented by 6.

One of the primary functions of an advertisement server is to provide accounting information on the effectiveness of a given advertising campaign. The effectiveness of advertising via the Internet is conventionally measured by monitoring the “click-through” rate associated with advertising. A “click-through” event occurs when a user interacts with an advertisement displayed within a Web page by “clicking” on the advertisement. Conventionally, every time an advertisement is served, and every time a user clicks on the advertisement, an advertisement server is notified. Advertisement servers maintain statistics on how many times each advertisement has been served, how many times it has been “clicked-on”, etc., even if an advertisement is served from multiple sites in multiple domains.

A new type of advertising interaction, referred to as “call-through”, is now being developed for use with Web-enabled telephones capable of supporting both Web and voice services. Instead of being directed to a Web site containing additional information, a user of a voice-enabled Web device can be connected via a voice connection to the advertiser. For example, by including a link of the form “wtai://wp/mc;9195551212” in an advertisement, a user can be connected to the advertiser (at phone number 919-555-1212) by clicking on the link.

Unfortunately, recording information (referred to as “accounting”) about a “call-through” event is difficult to perform via conventional wireless Web technology. Conventionally, a “gateway” device is positioned between a user device and an advertisement server. The gateway device translates between the protocols used by user devices and those used by the advertisement server. The gateway is configured to intercept redirections from an advertisement server and attempts to follow the redirections on behalf of a user device. Accordingly, using conventional wireless Web technology, an advertisement server is not notified when a user clicks on a link.

### SUMMARY OF THE INVENTION

In view of the above, the present invention provides systems, methods, and computer program products that facilitate and account for call-through advertising between third party advertisers and users of Web-enabled telephone devices. Upon receiving a request from a Web browser (or microbrowser) executing on a Web-enabled telephone device, an advertisement server serves an advertisement associated with a third party to the Web-enabled telephone device for insertion within a Web page displayed within the Web-enabled telephone device. According to embodiments of the present invention, the advertisement served by the advertisement server contains an embedded hyperlink associated with the advertisement server. In response to user activation of the displayed advertisement hyperlink (e.g., by clicking on the advertisement), the advertisement server serves telephone connection information of the third party associated with the displayed advertisement to the Web-enabled telephone device.

The telephone connection information is in a format that can be utilized by the Web-enabled telephone device to establish telephone communications with the third party. Information associated with serving the telephone connection information to the Web-enabled telephone device is stored, thereby accounting for the call-through event. To facilitate accounting for call-through marketing effectiveness, information associated with a user establishing telephone communications with the third party via the Web-enabled telephone device may also be stored.

According to embodiments of the present invention, upon receiving a request from a Web browser of a Web-enabled telephone device, an advertisement server serves an advertisement associated with a third party to the Web-enabled telephone device for insertion within a Web page displayed within the Web-enabled telephone device. The advertisement served by the advertisement server contains an embedded hyperlink associated with the advertisement server. In response to user activation of the displayed advertisement hyperlink (e.g., by clicking on the advertisement), the advertisement serves telephone connection information to the Web-enabled telephone device for a source of information associated with the advertisement (e.g., such that a user can find out more information). According to embodiments of the present invention, the source of information contains one or more prerecorded messages that are played to the user when telephone communications are established therewith. Alternatively, the source of information may include an actual person with whom the user could speak. The source of information may be hosted by the advertisement server or by a third party. Information associated with serving the telephone connection information associated with the source of information to the Web-enabled telephone device is stored. To facilitate accounting for call-through marketing effectiveness, information associated with a user establishing telephone communications with an information source via the Web-enabled telephone device may also be stored.

### BRIEF DESCRIPTION OF THE DRAWINGS

FIG. 1 is a block diagram that illustrates how advertisements are served from a conventional advertisement server.

FIGS. 2-3 are flowcharts that illustrate operations for facilitating and accounting for call-through advertising between advertisers and users of Web-enabled telephone devices, according to embodiments of the present invention.

FIGS. 4-5 are block diagrams that illustrate operations for facilitating and accounting for call-through advertising between advertisers and users of Web-enabled telephone devices, according to embodiments of the present invention.

FIG. 6 is a block diagram that illustrates a server computer system upon which embodiments of the present invention may be implemented or practiced.

FIGS. 7A-7C illustrate a sequence of screens presented to a user via a browser communicating with a server computer system according to embodiments of the present invention.

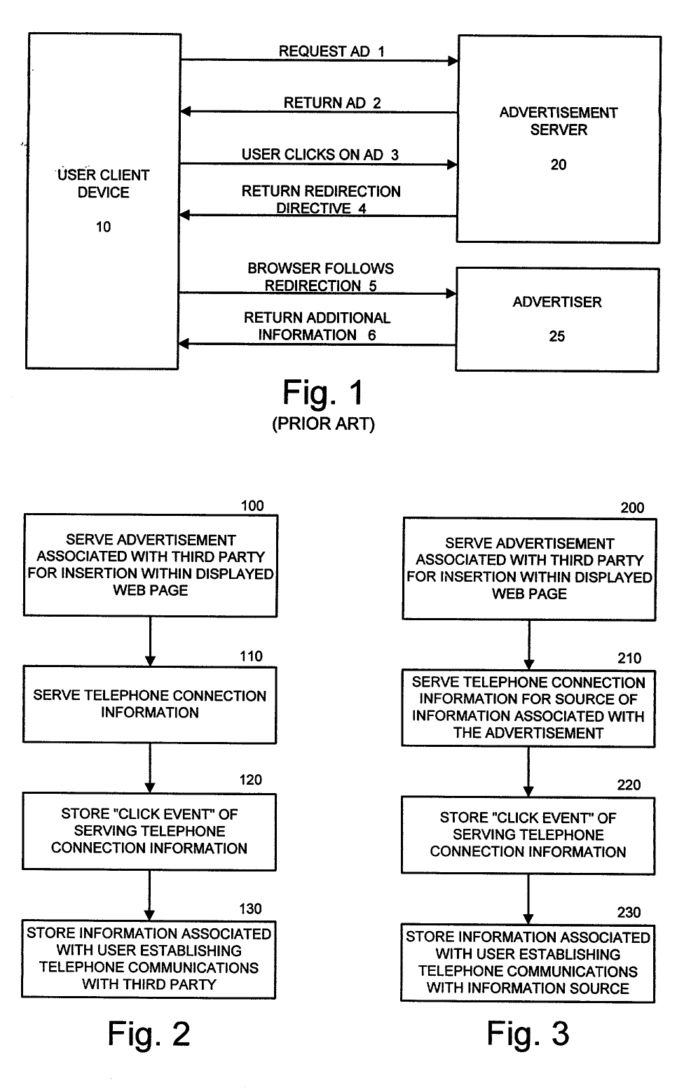

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As also will be appreciated by one of skill in the art, the present invention may be embodied as methods, data processing systems, and/or computer program products. Accordingly, the present invention may take the form of an entirely hardware embodiment, an entirely software embodiment running on general purpose hardware or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code for carrying out operations of the present invention may be written in an object oriented programming language (e.g., JAVA®, Smalltalk or C++) and/or may also be written in a conventional procedural programming language (e.g., “C”). However, software embodiments of the present invention do not depend on implementation with a particular programming language. Program code may execute entirely on one or more server computer systems.

The present invention is described below with reference to block diagram and flowchart illustrations of methods, apparatus (systems) and computer program products according to embodiments of the invention. It will be understood that each block of the block diagrams and/or flowchart illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create structures for implementing the functions specified in the block diagram and/or flowchart block or blocks. Each block, and combinations of blocks, can be implemented by servers which perform the specified functions or steps, or combinations of special purpose hardware and computer instructions.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

Referring now to FIG. 2, operations performed by an advertisement server, according to embodiments of the present invention, for facilitating and accounting for call-through advertising between advertisers and users of Web-enabled telephone devices, are illustrated. Exemplary Web-enabled telephone devices that may be utilized in accordance with embodiments of the present invention include, but are not limited to, personal computers with modems, portable computers with modems, handheld computers with modems, personal digital assistants (PDAs), pagers, cellular telephones, web phones, web-enabled radiotelephones, other mobile/wireless devices, and all types of wireline telephones.

Upon receiving a request from a Web browser (or microbrowser) executing on a Web-enabled telephone device, an advertisement server serves an advertisement associated with a third party to the Web-enabled telephone device for insertion within a Web page displayed within the Web-enabled telephone device (Block 100). For example, Web content may include a reference (e.g., a hyperlink) to an advertisement server, so that an advertisement (e.g., an image, etc.) is requested from the advertisement server, retrieved from the advertisement server (or another server), and displayed as part of a Web page within the browser. According to embodiments of the present invention, the advertisement served by the advertisement server contains an embedded hyperlink associated with the advertisement server.

In response to user activation of the displayed advertisement hyperlink (e.g., by clicking on the advertisement), the advertisement server serves telephone connection information of the third party associated with the displayed advertisement to the Web-enabled telephone device (Block 110). The telephone connection information is in a format that can be utilized by the Web-enabled telephone device to establish telephone communications with the third party. Stated differently, the Web-enabled telephone device can use the telephone connection information to dial a telephone number. For example, according to embodiments of the present invention, the telephone connection information is served as a telephony hyperlink within another Web page that is displayed within the Web-enabled telephone device. User activation of the telephony hyperlink causes the Web-enabled telephone device to establish telephone communications with the third party.

According to embodiments of the present invention, the Web-enabled telephone device may establish telephone communications with the third party when a user clicks on a hyperlink (e.g., “wtai://wp/mc;9195551212”) served to the user. Alternatively, the displayed Web page may contain a hyperlink that can be activated by a user to remove the displayed Web page from display within the Web-enabled telephone device.

Information associated with serving the telephone connection information to the Web-enabled telephone device is stored (Block 120). For example, the user's click on the advertisement (i.e., a click event) is recorded by the advertisement server. Moreover, information such as, but not limited to, an identification of the requesting Web browser, user, Web-enabled telephone device, as well as time and date information, may be recorded by the advertisement server for use in measuring effectiveness of a particular marketing (or advertising) campaign.

To facilitate accounting for call-through marketing effectiveness, information associated with a user establishing telephone communications with the third party via the Web-enabled telephone device may also be stored (Block 130). For example, a Web-enabled telephone device may be configured to communicate with an advertisement server to indicate when telephone communications with a third party were established. Alternatively, an advertisement server according to embodiments of the present invention may receive information from the third party.

According to embodiments of the present invention, a Web page displayed within a Web-enabled telephone device that contains telephone connection information may also include one or more advertisements that can be activated in a similar manner. For example, another advertisement, upon activation, may redirect the user's browser to another Web site, or may request other telephone connection information such that the user can establish telephone communications with a third party.

Referring now to FIG. 3, operations performed by an advertisement server, according to other embodiments of the present invention, for facilitating and accounting for call-through advertising between advertisers and users of Web-enabled telephone devices, are illustrated. Upon receiving a request from a Web browser of a Web-enabled telephone device, an advertisement server serves an advertisement associated with a third party to the Web-enabled telephone device for insertion within a Web page displayed within the Web-enabled telephone device (Block 200). As described above, Web content may include a reference (e.g., a hyperlink) to an advertisement server, so that an advertisement (e.g., an image, etc.) is requested from the advertisement server, retrieved from the advertisement server (or another server), and displayed as part of a Web page within the browser. According to embodiments of the present invention, the advertisement served by the advertisement server contains an embedded hyperlink associated with the advertisement server.

In response to user activation of the displayed advertisement hyperlink (e.g., by clicking on the advertisement), the advertisement server serves telephone connection information to the Web-enabled telephone device for a source of information associated with the advertisement (Block 210). According to embodiments of the present invention, the source of information contains one or more prerecorded messages that are played to the user when telephone communications are established therewith. The source of information may be hosted by the advertisement server or by a third party. Alternatively, a user may be connected with an actual person.

As described above, the telephone connection information is in a format that can be utilized by the Web-enabled telephone device to establish telephone communications with the source of information. For example, according to embodiments of the present invention, the telephone connection information is served as a telephony hyperlink within another Web page that is displayed within the Web-enabled telephone device. User activation of the telephony hyperlink causes the Web-enabled telephone device to establish telephone communications with the source of information. Alternatively, the Web-enabled telephone device may establish telephone communications with the source of information automatically upon receiving the telephone connection information. Additionally, the displayed Web page may contain a hyperlink that can be activated by a user to remove the displayed Web page from display within the Web-enabled telephone device.

Information associated with serving the telephone connection information associated with the source of information to the Web-enabled telephone device is stored (Block 220). For example, the user's click on the advertisement is recorded by the advertisement server. Moreover, information such as, but not limited to, an identification of the requesting Web browser, user, Web-enabled telephone device, as well as time and date information, may be recorded by the advertisement server for use in measuring effectiveness of a particular marketing (or advertising) campaign.

To facilitate accounting for call-through marketing effectiveness, information associated with a user establishing telephone communications with an information source via the Web-enabled telephone device may also be stored (Block 230). For example, a Web-enabled telephone device may be configured to communicate with an advertisement server to indicate when telephone communications with the information source were established. Alternatively, the advertisement server may receive information from the information source.

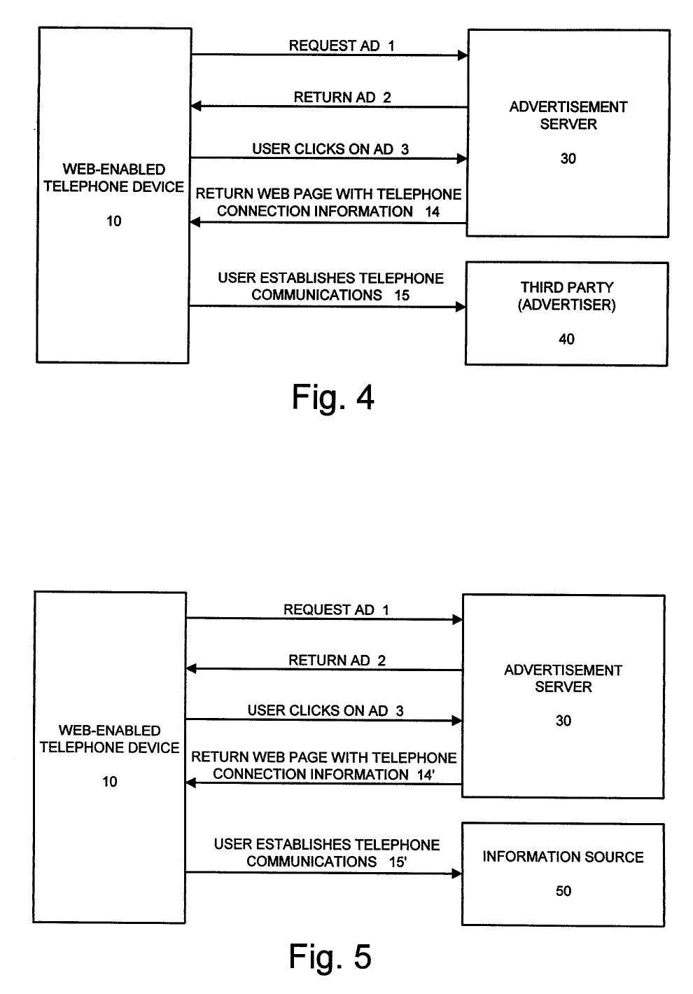

FIG. 4 is a block diagram that illustrates operations for facilitating and accounting for call-through advertising between advertisers and users of Web-enabled telephone devices, according to embodiments of the present invention. A browser executing within a Web-enabled telephone device 10 requests an advertisement from an advertisement server 30 according to embodiments of the present invention, represented by 1. The advertisement server 30 returns the advertisement to the Web-enabled telephone device for insertion within a displayed Web page, represented by 2. When a user clicks on the displayed advertisement, a request is sent to the advertisement server 30, represented by 3. In response, the advertisement server 30 returns a Web page containing telephone connection information for a third party associated with the “clicked-on” advertisement, represented by 14. The user can establish telephone communications with the third party 40 by clicking on the telephone connection information, represented by 15.

FIG. 5 is a block diagram that illustrates operations for facilitating and accounting for call-through advertising between advertisers and users of Web-enabled telephone devices, according to additional embodiments of the present invention. A browser executing within a Web-enabled telephone device 10 requests an advertisement from an advertisement server 30 according to embodiments of the present invention, represented by 1. The advertisement server 30 returns the advertisement to the Web-enabled telephone device for insertion within a displayed Web page, represented by 2. When a user clicks on the displayed advertisement, a request is sent to the advertisement server 30, represented by 3. In response, the advertisement server 30 returns a Web page containing telephone connection information that can be utilized by the Web-enabled telephone device to establish telephone communications with a source of information 50 associated with the advertisement, represented by 14′. As described above, the source of information 50 may be hosted by the advertisement server 30 and contains one or more prerecorded messages that are played to a user when telephone communications are established. The user can establish telephone communications with the information source 50 by clicking on the telephone connection information, represented by 15′.

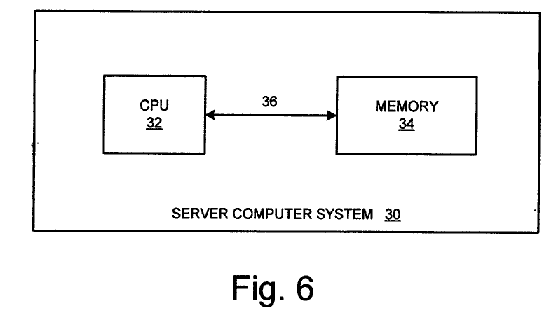

FIG. 6 is a block diagram that illustrates a server computer system (advertisement server) 30 upon which embodiments of the present invention may be implemented or practiced. The illustrated server computer system 30 includes a central processor (CPU) 32 and memory 34. The memory 34 is configured to store computer program instructions to be executed by the CPU 32 for performing the process steps represented by the flowcharts and block diagrams of FIGS. 2-5. The CPU 32 communicates with the memory 34 via an address/data bus 36.

The CPU 32 may be, for example, a commercially available or custom microprocessor. The memory 34 is representative of the overall hierarchy of memory devices containing software and data used to facilitate and account for call-through advertising between third party advertisers and users of Web-enabled telephone devices in accordance with embodiments of the present invention. The memory 34 may store other information and software such as applications programs, network communication programs (e.g., TCP/IP protocol), operating system software, server software, such as HTTP server software, etc. The memory 34 may include, but is not limited to, the following types of devices: cache, ROM, PROM, EPROM, EEPROM, flash, SRAM, and DRAM.

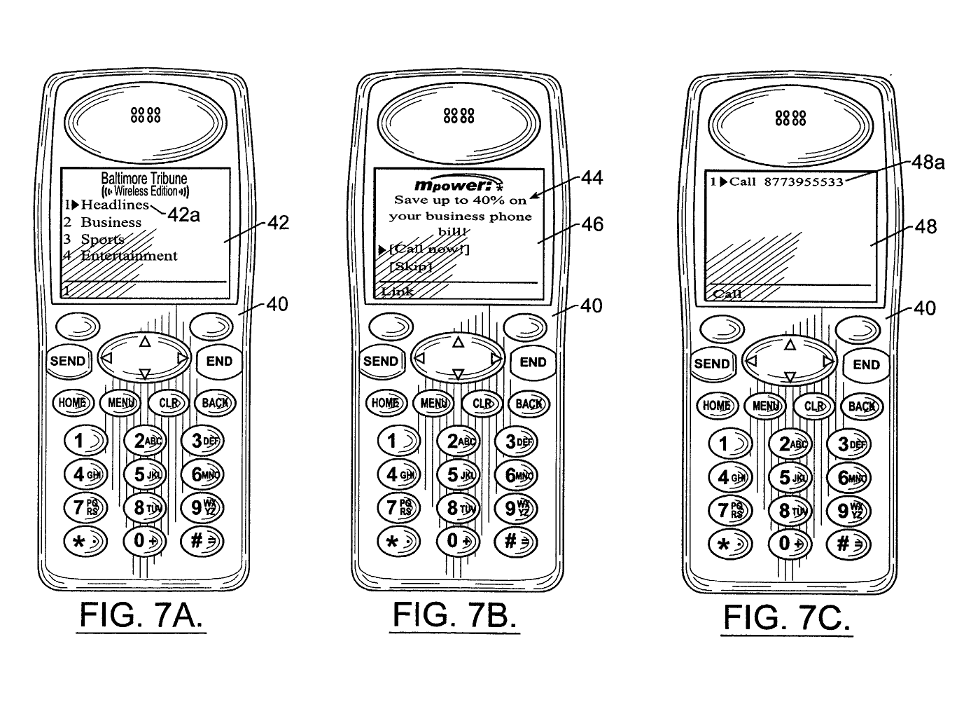

FIGS. 7A-7C illustrate a sequence of what a user would see via a browser executing on a Web-enabled telephone device 40, according to embodiments of the present invention. In FIG. 7A, the user is viewing a Web page 42 from a Web site. Upon “clicking on” the first link 42a, an advertisement server (30, FIG. 6) according to embodiments of the present invention, serves an advertisement 44 for display within a Web page 46. (FIG. 7B). Included in the Web page 46 of FIG. 7B is a link that, when activated by a user, the click event is recorded by the advertisement server and the advertisement server returns a Web page 48 that includes a link 48a to automatically call the advertiser (or other third party).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of facilitating and accounting for call-through advertising between advertisers and users of Web-enabled telephone devices, the method comprising the following performed by an advertisement server:
serving an advertisement associated with a third party to a Web-enabled telephone device for insertion within a Web page displayed within the Web-enabled telephone device, wherein the advertisement contains an embedded hyperlink associated with the advertisement server;
responsive to user activation of the advertisement hyperlink, serving telephone connection information of the third party to the Web-enabled telephone device, wherein the telephone connection information is in a format that can be utilized by the Web-enabled telephone to establish telephone communications with the third party; and
storing information associated with serving the telephone connection information to the Web-enabled telephone device.

2. The method of claim 1, further comprising storing information associated with a user establishing telephone communications with the third party via the Web-enabled telephone device.

3. The method of claim 1, wherein serving telephone connection information of the third party to the Web-enabled telephone device comprises serving a telephony hyperlink within a second Web page that is displayed within the Web-enabled telephone device, and wherein user activation of the telephony hyperlink causes the Web-enabled telephone device to establish telephone communications with the third party.

4. The method of claim 3, wherein the second Web page contains a hyperlink that can be activated by a user to remove the second Web page from display within the Web-enabled telephone device.

5. The method of claim 3, wherein the second Web page comprises a second advertisement that contains an embedded hyperlink associated with an advertisement server.

6. The method of claim 1, wherein serving the advertisement to the Web-enabled telephone device is responsive to user activation of a hyperlink displayed within the Web-enabled telephone device.

7. A method of facilitating and accounting for call-through advertising between advertisers and users of Web-enabled telephone devices, the method comprising the following performed by an advertisement server:
serving an advertisement associated with a third party to a Web-enabled telephone device for insertion within a Web page displayed within the Web-enabled telephone device, wherein the advertisement contains an embedded hyperlink associated with the advertisement server;
responsive to user activation of the advertisement hyperlink, serving telephone connection information to the Web-enabled telephone device, wherein the telephone connection information is in a format that can be utilized by the Web-enabled telephone device to establish telephone communications with a source of information associated with the advertisement, wherein the source of information is hosted by the advertisement server; and
storing information associated with serving the telephone connection information to the Web-enabled telephone device.

8. The method of claim 7, further comprising storing information associated with a user establishing telephone communications with the source of information via the Web-enabled telephone.

9. The method of claim 7, wherein serving telephone connection information to the Web-enabled telephone device comprises serving a telephony hyperlink within a second Web page that is displayed within the Web-enabled telephone device, and wherein user activation of the telephony hyperlink causes the Web-enabled telephone device to establish telephone communications with the source of information.

10. The method of claim 7, wherein the source of information contains prerecorded information associated with the advertisement that is configured to be played to the user when telephone communications are established with the source of information via the Web-enabled telephone.

11. The method of claim 9, wherein the second Web page contains a hyperlink that can be activated by a user to remove the second Web page from display within the Web-enabled telephone device.

12. The method of claim 9, wherein the second Web page comprises a second advertisement that contains an embedded hyperlink associated with an advertisement server.

13. The method of claim 7, wherein serving the advertisement to the Web-enabled telephone device is responsive to user activation of a hyperlink displayed within the Web-enabled telephone device.

14. A server computer system that facilitates and accounts for call-through advertising between advertisers and users of Web-enabled telephone devices, comprising:
means for serving an advertisement associated with a third party to a Web-enabled telephone device for insertion within a Web page displayed within the Web-enabled telephone device, wherein the advertisement contains an embedded hyperlink associated with the server computer system;
means, responsive to user activation of the advertisement hyperlink, for serving telephone connection information of the third party to the Web-enabled telephone device, wherein the telephone connection information is in a format that can be utilized by the Web-enabled telephone device to establish telephone communications with the third party; and
means for storing information associated with serving the telephone connection information to the Web-enabled telephone device.

15. The server computer system of claim 14, further comprising means for storing information associated with a user establishing telephone communications with the third party via the Web-enabled telephone device.

16. The server computer system of claim 14, wherein the means for serving telephone connection information of the third party to the Web-enabled telephone device comprises means for serving a telephony hyperlink within a second Web page that is displayed within the Web-enabled telephone device, and wherein user activation of the telephony hyperlink causes the Web-enabled telephone device to establish telephone communications with the third party.

17. The server computer system of claim 16, wherein the second Web page contains a hyperlink that can be activated by a user to remove the second Web page from display within the Web-enabled telephone device.

18. The server computer system of claim 16, wherein the second Web page comprises a second advertisement that contains an embedded hyperlink associated with the server computer system.

19. The server computer system of claim 16, wherein the second Web page comprises a second advertisement that contains an embedded hyperlink associated with another server computer system.

20. The server computer system of claim 14, wherein the means for serving the advertisement to the Web-enabled telephone device is responsive to user activation of a hyperlink displayed within the Web-enabled telephone device.

21. The server computer system of claim 14, wherein the means for serving the advertisement to the Web-enabled telephone device is responsive to user activation of a hyperlink displayed within the Web-enabled telephone device.

22. A server computer system that facilitates and accounts for call-through advertising between advertisers and users of Web-enabled telephone devices, comprising:
means for serving an advertisement associated with a third party to a Web-enabled telephone device for insertion within a Web page displayed within the Web-enabled telephone device, wherein the advertisement contains an embedded hyperlink associated with the server computer system;
means, responsive to user activation of the advertisement hyperlink, for serving telephone connection information to the Web-enabled telephone device, wherein the telephone connection information is in a format that can be utilized by the Web-enabled telephone device to establish telephone communications with a source of information associated with the advertisement, wherein the source of information is hosted by the server computer system; and
means for storing information associated with serving the telephone connection information to the Web-enabled telephone device.

23. The server computer system of claim 22, further comprising means for storing information associated with a user establishing telephone communications with the source of information via the Web-enabled telephone.

24. The server computer system of claim 22, wherein the means for serving telephone connection information to the Web-enabled telephone device comprises means for serving a telephony hyperlink within a second Web page that is displayed within the Web-enabled telephone device, and wherein user activation of the telephony hyperlink causes the Web-enabled telephone device to establish telephone communications with the source of information.

25. The server computer system of claim 22, wherein the source of information contains prerecorded information associated with the advertisement that is configured to be played to the user when telephone communications are established with the source of information via the Web-enabled telephone.

26. The server computer system of claim 24, wherein the second Web page contains a hyperlink that can be activated by a user to remove the second Web page from display within the Web-enabled telephone device.

27. The server computer system of claim 24, wherein the second Web page comprises a second advertisement that contains an embedded hyperlink associated with a server computer system.

28. The server computer system of claim 22, wherein the means for serving the advertisement to the Web-enabled telephone device is responsive to user activation of a hyperlink displayed within the Web-enabled telephone device.

29. A computer program product that facilitates and accounts for call-through advertising between advertisers and users of Web-enabled telephone devices, the computer program product comprising a computer usable storage medium having computer readable program code embodied in the medium, the computer readable program code comprising:
computer readable program code that serves an advertisement associated with a third party to a Web-enabled telephone device for insertion within a Web page displayed within the Web-enabled telephone device, wherein the advertisement contains an embedded hyperlink associated with the server computer system;
computer readable program code that, responsive to user activation of the advertisement hyperlink, serves telephone connection information of the third party to the Web-enabled telephone device, wherein the telephone connection information is in a format that can be utilized by the Web-enabled telephone device to establish telephone communications with the third party; and
computer readable program code that stores information associated with serving the telephone connection information to the Web-enabled telephone device.

30. The computer program product of claim 29, further comprising computer readable program code that stores information associated with a user establishing telephone communications with the third party via the Web-enabled telephone device.

31. The computer program product of claim 29, wherein the computer readable program code that serves telephone connection information of the third party to the Web-enabled telephone device comprises computer readable program code that serves a telephony hyperlink within a second Web page that is displayed within the Web-enabled telephone device, and wherein user activation of the telephony hyperlink causes the Web-enabled telephone device to establish telephone communications with the third party.

32. The computer program product of claim 31, wherein the second Web page contains a hyperlink that can be activated by a user to remove the second Web page from display within the Web-enabled telephone device.

33. The computer program product of claim 31, wherein the second Web page comprises a second advertisement that contains an embedded hyperlink associated with the server computer system.

34. The computer program product of claim 31, wherein the second Web page comprises a second advertisement that contains an embedded hyperlink associated with another server computer system.

35. The computer program product of claim 29, wherein the computer readable program code that serves the advertisement to the Web-enabled telephone device is responsive to user activation of a hyperlink displayed within the Web-enabled telephone device.

36. The computer program product of claim 29, wherein the computer readable program code that serves the advertisement to the Web-enabled telephone device is responsive to user activation of a hyperlink displayed within the Web-enabled telephone device.

37. A computer program product that facilitates and accounts for call-through advertising between advertisers and users of Web-enabled telephone devices, the computer program product comprising a computer usable storage medium having computer readable program code embodied in the medium, the computer readable program code comprising:
computer readable program code that serves an advertisement associated with a third party to a Web-enabled telephone device for insertion within a Web page displayed within the Web-enabled telephone device, wherein the advertisement contains an embedded hyperlink associated with the server computer system;
computer readable program code that, responsive to user activation of the advertisement hyperlink, serves telephone connection information to the Web-enabled telephone device, wherein the telephone connection information is in a format that can be utilized by the Web-enabled telephone device to establish telephone communications with a source of information associated with the advertisement, wherein the source of information is hosted by the server computer system; and
computer readable program code that stores information associated with serving the telephone connection information to the Web-enabled telephone device.

38. The computer program product of claim 37, further comprising computer readable program code that stores information associated with a user establishing telephone communications with the source of information via the Web-enabled telephone.

39. The computer program product of claim 37, wherein the computer readable program code that serves telephone connection information to the Web-enabled telephone device comprises computer readable program code that serves a telephony hyperlink within a second Web page that is displayed within the Web-enabled telephone device, and wherein user activation of the telephony hyperlink causes the Web-enabled telephone device to establish telephone communications with the source of information.

40. The computer program product of claim 37, wherein the source of information contains prerecorded information associated with the advertisement that is configured to be played to the user when telephone communications are established with the source of information via the Web-enabled telephone.

41. The computer program product of claim 39, wherein the second Web page contains a hyperlink that can be activated by a user to remove the second Web page from display within the Web-enabled telephone device.

42. The computer program product of claim 39, wherein the second Web page comprises a second advertisement that contains an embedded hyperlink associated with a server computer system.

43. The computer program product of claim 37, wherein the computer readable program code that serves the advertisement to the Web-enabled telephone device is responsive to user activation of a hyperlink displayed within the Web-enabled telephone device.
